(19) United States
(12) Patent Application Publication
(10) Pub. No.: US 2025/0108265 A1
(43) Pub. Date: Apr. 3, 2025

(54) GOLF BALL

(71) Applicant: BRIDGESTONE SPORTS CO., LTD., Tokyo (JP)

(72) Inventor: Katsunobu MOCHIZUKI, Chichibushi (JP)

(73) Assignee: BRIDGESTONE SPORTS CO., LTD., Tokyo (JP)

(21) Appl. No.: 18/896,200

(22) Filed: Sep. 25, 2024

(30) Foreign Application Priority Data
Sep. 28, 2023 (JP) 2023-166774

(51) Int. Cl. A63B 37/00; C08L 75/04

(52) U.S. Cl. CPC A63B 37/0027; A63B 37/003; A63B 37/0036; A63B 37/0074; C08L 75/04

(57) ABSTRACT

In a golf ball having a rubber core of at least one layer and a cover of at least one layer encasing the core, at least one layer of the cover is formed of a resin composition that includes (I) a polyurethane or a polyurea and (II) an aromatic vinyl elastomer, the amount of component (II) included per 100 parts by weight of component (I) is less than 15 parts by weight, and the CS₁ value calculated by formula (1) below

$$C {S}_{1} = ( C {V}_{50} - C {V}_{12} ) / 38 \qquad ( 1 )$$

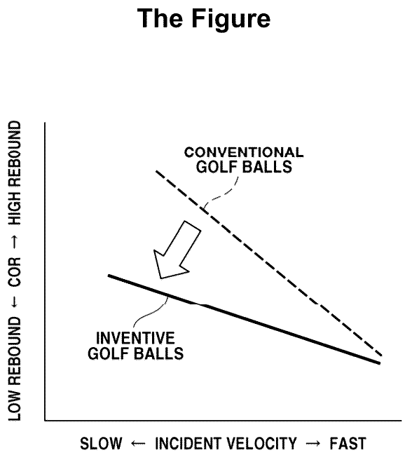

(wherein CV₅₀ is the coefficient of restitution at an incident velocity of 50.0 m/s and CV₁₂ is the coefficient of restitution at an incident velocity of 12.0 m/s) is larger than −4.08×10⁻³, so that the golf ball has both an excellent controllability and a good feel at impact on approach shots together with a good scuff resistance.

### CROSS-REFERENCE TO RELATED APPLICATIONS

This non-provisional application claims priority under 35 U.S.C. § 119(a) on Patent Application No. 2023-166774 filed in Japan on Sep. 28, 2023, the entire contents of which are hereby incorporated by reference.

### TECHNICAL FIELD

The present invention relates to a golf ball having a core of at least one layer and a cover of at least one layer.

### BACKGROUND ART

The property most desired in a golf ball is increased distance, but other desirable properties include the ability for the ball to stop well on approach shots and a good scuff resistance. Many golf balls have hitherto been developed that exhibit a good flight performance on shots with a driver and are suitably receptive to backspin on approach shots. Recently, in golf balls for professional golfers and skilled amateurs, urethane resin materials are often used in place of ionomer resin materials as the cover material.

A number of cover materials that are polymer blends obtained by mixing a urethane resin as the base resin with other resin materials have been described in the art. For example, in order to improve the scuff resistance of the cover material, JP-A H11-9721 describes the use of a blend of a thermoplastic polyurethane and a styrene-base block copolymer as the chief material of the cover. However, covers made of this blend are inadequate in terms of their rebound resilience and scuff resistance.

JP-A 2021-3451 discloses a golf ball which, by employing as the cover material a resin composition obtained by blending an aromatic vinyl elastomer with a polyurethane resin material, has an excellent controllability on approach shots and is able to maintain a good scuff resistance without a loss of distance on shots with a driver. However, even this golf ball has an inadequate spin rate on approach shots. Hence there exists a desire for the spin rate to be further increased and for the controllability to be improved even more while retaining a good scuff resistance.

### SUMMARY OF THE INVENTION

It is therefore an object of the present invention to provide a golf ball which, compared with golf balls having a conventional urethane cover, is endowed with an excellent controllability on approach shots and possesses a good scuff resistance.

As a result of intensive investigations, I have discovered that by formulating, as the cover material for a golf ball having a core and a cover, a polymer blend that is a resin material composed primarily of a polyurethane or a polyurea and includes less than a specific amount of an aromatic vinyl elastomer and producing a golf ball in which a molding of this resin material serves as the cover such that the CS₁ value calculated by formula (1) below

$$C {S}_{1} = ( C {V}_{50} - C {V}_{12} ) / 38 \qquad ( 1 )$$

(wherein CV₅₀ is the ball coefficient of restitution (COR) at an incident velocity of 50.0 m/s and CV₁₂ is the ball COR at an incident velocity of 12.0 m/s) is larger than −4.08×10⁻³, the golf ball has an excellent controllability on approach shots, has a good feel at impact on approach shots, and moreover possesses a good scuff resistance.

I have also found that by including less than a specific amount of an aromatic vinyl elastomer in a urethane resin material, the COR of the golf ball decreases at a low initial velocity but does not decrease at a high initial velocity, making this effective for achieving good ball controllability on approach shots. In particular, by using as the aromatic vinyl elastomer a completely saturated isobutylene-styrene thermoplastic elastomer which has a low melt flow rate (MFR) and is composed of polymer blocks made of styrene at both ends and polymer blocks made of isobutylene in between, the dispersibility is good, making it possible to achieve, in terms of the ball properties, both a high spin rate and a good feel at impact on approach shots.

Accordingly, the invention provides a golf ball having a rubber core of at least one layer and a cover of at least one layer encasing the core, wherein at least one layer of the cover is formed of a resin composition which includes:
(I) a polyurethane or a polyurea, and
(II) an aromatic vinyl elastomer;
   the amount of component (II) included per 100 parts by weight of component (I) is less than 15 parts by weight; and
   the CS₁ value calculated by formula (1) below

$$C {S}_{1} = ( C {V}_{50} - C {V}_{12} ) / 38 \qquad ( 1 )$$

(wherein CV₅₀ is the coefficient of restitution at an incident velocity of 50.0 m/s and CV₁₂ is the coefficient of restitution at an incident velocity of 12.0 m/s) is larger than −4.08×10⁻³.

In a preferred embodiment of the golf ball of the invention, the CS₂ value calculated by formula (2) below

$$C {S}_{2} = ( 1. - {CV}_{12 / 45} ) / 33 \qquad ( 2 )$$

(wherein CV_{12/45} is the coefficient of restitution at an incident velocity of 12.0 m/s when the coefficient of restitution at an incident velocity of 45.0 m/s is set to 1.0) is larger than −5.23×10⁻³.

In another preferred embodiment of the inventive golf ball, component (II) has a melt flow rate (MFR), as measured at 230° C. and under a load of 2.16 kgf (ISO 1133), which is smaller than 12 g/10 min.

In yet another preferred embodiment, component (II) is a completely saturated isobutylene-styrene thermoplastic elastomer having polymer blocks made of styrene at both ends and a polymer block made of isobutylene in between. In this embodiment, the styrene content of component (II) may be 15 wt % or more. Alternatively, the styrene content of component (II) may be from 15 to 30 wt %.

In still another preferred embodiment, component (II) has a rebound resilience of from 20 to 40%.

In a further embodiment, component (II) has a Shore D hardness of 23 or less.

### Advantageous Effects of the Invention

Compared with conventional golf balls having a urethane cover, the golf ball of the invention exhibits a superior controllability on approach shots, in addition to which it has a good feel at impact on approach shots and moreover is able to maintain a good scuff resistance.

### BRIEF DESCRIPTION OF THE DRAWINGS

The FIGURE is a graph showing the relationship between the incident velocity and the coefficient of resilience (COR) in golf balls according to the invention and conventional golf balls.

### DETAILED DESCRIPTION OF THE INVENTION

The objects, features and advantages of the invention will become more apparent from the following detailed description taken in conjunction with the appended diagram.

It is critical for the golf ball of the invention to have a CS₁ value calculated according to formula (1) below which is larger than −4.08×10⁻³

$$C {S}_{1} = ( C {V}_{50} - C {V}_{12} ) / 38 \qquad ( 1 )$$

(wherein CV₅₀ is the coefficient of restitution at an incident velocity of 50.0 m/s and CV₁₂ is the coefficient of restitution at an incident velocity of 12.0 m/s).

As shown in the FIGURE, at a fast incident velocity, the golf ball of the invention has a COR which does not differ much from that of conventional golf balls, but at slower incident velocities, the COR becomes lower and the slope of the straight-line graph becomes smaller. CS₁=(CV₅₀−CV₁₂)/38 signifies the slope of this straight-line graph. That is, when the value of CS₁ is larger than −4.08×10⁻³, the COR decreases in the low initial velocity range, but does not decrease in the high initial velocity range, which is effective for ball controllability on approach shots. In above formula (1), using CV₁₂ (incident velocity, 12.0 m/s) corresponds to striking conditions on a 15-yard approach shot at a head speed (HS) of about 11 to 13 m/s, and using CV₅₀ (incident velocity, 50.0 m/s) corresponds to striking conditions with a driver (W #1) by a topflight professional golfer or a skilled amateur.

In addition, the golf ball of the invention preferably has a CS₂ value calculated according to the following formula (2)

$$C {S}_{2} = ( 1. - {CV}_{12 / 45} ) / 33 \qquad ( 2 )$$

(wherein CV_{12/45} is the coefficient of restitution at an incident velocity of 12.0 m/s when the coefficient of restitution at an incident velocity of 45.0 m/s is set to 1.0) which is larger than −5.23×10⁻³.

In formula (2), the reason for using CV₁₂ (incident velocity, 12.0 m/s) is that this corresponds to the striking conditions on a 15-yard approach shot at a head speed (HS) of about 11 to 13 m/s, and the reason for using CV₄₅ (incident velocity, 45.0 m/s) as the reference is that this corresponds to the striking conditions with a driver (W #1) by an ordinary male amateur golfer.

The golf ball of the invention has a core of at least one layer and a cover of at least one layer—that is, a single-layer or multilayer cover—that encases the core.

The core may be formed using a known rubber material as the base material. A known base rubber such as a natural rubber or a synthetic rubber may be used as the base rubber. More specifically, it is recommended that polybutadiene, especially cis-1,4-polybutadiene having a cis structure content of at least 40%, be chiefly used. If desired, natural rubber, polyisoprene rubber, styrene-butadiene rubber or the like may be used together with the foregoing polybutadiene in the base rubber.

The polybutadiene may be synthesized with a metal catalyst, such as a neodymium or other rare-earth catalyst, a cobalt catalyst or a nickel catalyst.

Co-crosslinking agents such as unsaturated carboxylic acids and metal salts thereof, inorganic fillers such as zinc oxide, barium sulfate and calcium carbonate, and organic peroxides such as dicumyl peroxide and 1,1-bis(t-butylperoxy)cyclohexane may be included in the base rubber. If necessary, commercial antioxidants and the like may be suitably added.

The core may be produced by vulcanizing/curing the rubber composition containing the above ingredients. For example, production may be carried out by kneading the composition using a mixer such as a Banbury mixer or a roll mill, compression molding or injection molding the kneaded composition using a core mold, and curing the molded body by suitably heating it at a temperature sufficient for the organic peroxide and the co-crosslinking agent to act, i.e., from 100° C. to 200° C., preferably from 140 to 180° C., for a period of between 10 and 40 minutes.

In the golf ball of the invention, the core is encased by a single-layer or multilayer cover. Such a golf ball may take the form of, for example, a golf ball having a single-layer cover over a core, or a golf ball having a core, an intermediate layer encasing the core, and an outermost layer encasing the intermediate layer.

In this invention, at least one layer of the cover is formed of a resin composition containing components (I) and (II) below:
(I) a polyurethane or a polyurea
(II) an aromatic vinyl elastomer.

### [(I) Polyurethane or Polyurea]

The polyurethane or polyurea is a substance which can serve as the chief material, or base resin, of the above cover material (resin composition). The polyurethane (I-a) or polyurea (I-b) used as this component is described in detail below.

### (I-a) Polyurethane

The polyurethane has a structure which includes soft segments composed of a polymeric polyol (polymeric glycol) that is a long-chain polyol and hard segments composed of a chain extender and a polyisocyanate. Here, the polymeric polyol serving as a starting material may be any that has hitherto been used in the art relating to polyurethane materials, and is not particularly limited. It is exemplified by polyester polyols, polyether polyols, polycarbonate polyols, polyester polycarbonate polyols, polyolefin polyols, conjugated diene polymer-based polyols, castor oil-based polyols, silicone-based polyols and vinyl polymer-based polyols. Specific examples of polyester polyols that may be used include adipate-type polyols such as polyethylene adipate glycol, polypropylene adipate glycol, polybutadiene adipate glycol and polyhexamethylene adipate glycol; and lactone-type polyols such as polycaprolactone polyol. Examples of polyether polyols include poly(ethylene glycol), poly(propylene glycol), poly(tetramethylene glycol) and poly(methyltetramethylene glycol). These polyols may be used singly, or two or more may be used in combination.

It is preferable to use a polyether polyol as the polymeric polyol.

The long-chain polyol has a number-average molecular weight that is preferably in the range of 1,000 to 5,000. By using a long-chain polyol having a number-average molecular weight in this range, golf balls that are made with polyurethane compositions and have excellent properties, including a good rebound and good productivity, can be reliably obtained. The number-average molecular weight of the long-chain polyol is more preferably in the range of 1,500 to 4,000, and even more preferably in the range of 1,700 to 3,500.

Here and below, “number-average molecular weight” refers to the number-average molecular weight calculated based on the hydroxyl value measured in accordance with JIS-K1557.

The chain extender is not particularly limited; any chain extender that has hitherto been employed in the art relating to polyurethanes may be suitably used. In this invention, low-molecular-weight compounds with a molecular weight of 2,000 or less which have on the molecule two or more active hydrogen atoms capable of reacting with isocyanate groups may be used. Of these, preferred use can be made of aliphatic diols having from 2 to 12 carbon atoms. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred.

Any polyisocyanate hitherto employed in the art relating to polyurethanes may be suitably used without particular limitation as the polyisocyanate. For example, use can be made of one or more selected from the group consisting of 4,4′-diphenylmethane diisocyanate, 2,4-toluene diisocyanate, 2,6-toluene diisocyanate, p-phenylene diisocyanate, xylylene diisocyanate, 1,5-naphthylene diisocyanate, tetramethylxylene diisocyanate, hydrogenated xylylene diisocyanate, dicyclohexylmethane diisocyanate, tetramethylene diisocyanate, hexamethylene diisocyanate, isophorone diisocyanate, norbornene diisocyanate, trimethylhexamethylene diisocyanate, 1,4-bis(isocyanatomethyl)cyclohexane and dimer acid diisocyanate. However, depending on the type of isocyanate, crosslinking reactions during injection molding may be difficult to control.

The ratio of active hydrogen atoms to isocyanate groups in the polyurethane-forming reaction may be suitably adjusted within a preferred range. Specifically, in preparing a polyurethane by reacting the above long-chain polyol, polyisocyanate and chain extender, it is preferable to use the respective components in proportions such that the amount of isocyanate groups included in the polyisocyanate per mole of active hydrogen atoms on the long-chain polyol and the chain extender is from 0.95 to 1.05 moles.

The method of preparing the polyurethane is not particularly limited. Preparation using the long-chain polyol, chain extender and polyisocyanate may be carried out by either a prepolymer process or a one-shot process via a known urethane-forming reaction. Of these, melt polymerization in the substantial absence of solvent is preferred. Production by continuous melt polymerization using a multiple screw extruder is especially preferred.

It is preferable to use a thermoplastic polyurethane material as the polyurethane, with an ether-based thermoplastic polyurethane material being especially preferred. The thermoplastic polyurethane material may be a commercial product, illustrative examples of which include those available under the registered trademark PANDEX from DIC Covestro Polymer, Ltd. and those available under the trade name RESAMINE from Dainichiseika Color & Chemicals Mfg. Co., Ltd.

### (I-b) Polyurea

The polyurea is a resin composition composed primarily of urea linkages formed by reacting (i) an isocyanate with (ii) an amine-terminated compound. This resin composition is described in detail below.

### (i) Isocyanate

The isocyanate is not particularly limited, but is preferably one that has hitherto been used in the prior art relating to polyurethanes. Use can be made of isocyanates similar to those mentioned above in connection with the polyurethane material.

### (ii) Amine-Terminated Compound

The amine-terminated compound is a compound having an amino group at the end of the molecular chain. The long-chain polyamines and/or amine curing agents indicated below may be used in this invention.

A long-chain polyamine is an amine compound which has on the molecule two or more amino groups capable of reacting with isocyanate groups and which has a number-average molecular weight of from 1,000 to 5,000. In this invention, the number-average molecular weight is more preferably from 1,500 to 4,000, and even more preferably from 1,900 to 3,000. Examples of such long-chain polyamines include, but are not limited to, amine-terminated hydrocarbons, amine-terminated polyethers, amine-terminated polyesters, amine-terminated polycarbonates, amine-terminated polycaprolactones, and mixtures thereof. These long-chain polyamines may be used singly, or two or more may be used in combination.

The amine curing agent is an amine compound which has on the molecule two or more amino groups capable of reacting with isocyanate groups and which has a number-average molecular weight of less than 1,000. In this invention, the number-average molecular weight is more preferably less than 800, and even more preferably less than 600. Specific examples of such amine curing agents include, but are not limited to, ethylenediamine, hexamethylenediamine, 1-methyl-2,6-cyclohexyldiamine, tetrahydroxypropylene ethylenediamine, 2,2,4- and 2,4,4-trimethyl-1,6-hexanediamine, 4,4′-bis(sec-butylamino)dicyclohexylmethane, 1,4-bis(sec-butylamino)cyclohexane, 1,2-bis(sec-butylamino)cyclohexane, derivatives of 4,4′-bis(sec-butylamino)dicyclohexylmethane, 4,4′-dicyclohexylmethanediamine, 1,4-cyclohexane bis(methylamine), 1,3-cyclohexane bis(methylamine), diethylene glycol di(aminopropyl) ether, 2-methylpentamethylenediamine, diaminocyclohexane, diethylenetriamine, triethylenetetramine, tetraethylenepentamine, propylenediamine, 1,3-diaminopropane, dimethylaminopropylamine, diethylaminopropylamine, dipropylenetriamine, imidobis(propylamine), monoethanolamine, diethanolamine, triethanolamine, monoisopropanolamine, diisopropanolamine, isophoronediamine, 4,4′-methylenebis(2-chloroaniline), 3,5-dimethylthio-2,4-toluenediamine, 3,5-dimethylthio-2,6-toluenediamine, 3,5-diethylthio-2,4-toluenediamine, 3,5-diethylthio-2,6-toluenediamine, 4,4′-bis(sec-butylamino)diphenylmethane and derivatives thereof, 1,4-bis(sec-butylamino)benzene, 1,2-bis(sec-butylamino)benzene, N,N′-dialkylaminodiphenylmethane, N,N,N′,N′-tetrakis(2-hydroxypropyl)ethylenediamine, trimethylene glycol di-p-aminobenzoate, polytetramethylene oxide di-p-aminobenzoate, 4,4′-methylenebis(3-chloro-2,6-diethyleneaniline), 4,4′-methylenebis(2,6-diethylaniline), m-phenylenediamine, p-phenylenediamine and mixtures thereof. These amine curing agents may be used singly or two or more may be used in combination.

(iii) Polyol

Although not an essential ingredient, in addition to above components (i) and (ii), a polyol may also be included in the polyurea. The polyol is not particularly limited, but is preferably one that has hitherto been used in the art relating to polyurethanes. Specific examples include the long-chain polyols and/or polyol curing agents indicated below.

The long-chain polyol may be any that has hitherto been used in the art relating to polyurethanes. Examples include, but are not limited to, polyester polyols, polyether polyols, polycarbonate polyols, polyester polycarbonate polyols, polyolefin-based polyols, conjugated diene polymer-based polyols, castor oil-based polyols, silicone-based polyols and vinyl polymer-based polyols. These long-chain polyols may be used singly or two or more may be used in combination.

The long-chain polyol has a number-average molecular weight of preferably from 1,000 to 5,000, and more preferably from 1,700 to 3,500. In this average molecular weight range, an even better rebound and productivity are obtained.

The polyol curing agent is preferably one that has hitherto been used in the art relating to polyurethanes, but is not particularly limited. In this invention, use may be made of a low-molecular-weight compound having on the molecule two or more active hydrogen atoms capable of reacting with isocyanate groups and having a molecular weight of less than 1,000. Of these, the use of aliphatic diols having from 2 to 12 carbon atoms is preferred. Specific examples include 1,4-butylene glycol, 1,2-ethylene glycol, 1,3-butanediol, 1,6-hexanediol and 2,2-dimethyl-1,3-propanediol. The use of 1,4-butylene glycol is especially preferred. The polyol curing agent has a number-average molecular weight that is preferably less than 800, and more preferably less than 600.

A known method may be used to produce the polyurea. A prepolymer process, a one-shot process or some other known method may be suitably selected for this purpose.

Component (I) has a material hardness on the Shore D hardness scale which, from the standpoint of the spin properties and scuff resistance that can be obtained in the golf ball, is preferably 52 or less, more preferably 50 or less, and even more preferably 48 or less. From the standpoint of the moldability, the lower limit in the material hardness on the Shore D scale is preferably 38 or more, and more preferably 40 or more.

Component (I) has a rebound resilience which, in terms of the overall ball performance, such as the initial velocity performance and spin performance when struck, is preferably 55% or more, more preferably 57% or more, and even more preferably 59% or more. The rebound resilience is measured based on JIS-K 6255: 2013.

Component (I) serves as the base resin of the resin composition. To fully confer the scuff resistance of a urethane resin, it accounts for at least 50 wt %, preferably at least 60 wt %, more preferably at least 70 wt %, even more preferably at least 80 wt %, and most preferably at least 90 wt %, of the resin composition.

In this invention, by blending component (II) described in detail below with above component (I), a golf ball of excellent controllability on approach shots and scuff resistance can be obtained.

### [(II) Aromatic Vinyl Elastomer]

Next, the aromatic vinyl elastomer (II) is described.

The aromatic vinyl elastomer (II), when used together with above component (I) serving as the base resin, can satisfactorily increase the controllability without a loss in the spin performance. Also, the aromatic vinyl elastomer (II), when included at or below a given small amount, has a good compatibility with component (I) serving as the base resin, enabling a good scuff resistance to be maintained in the golf ball.

The aromatic vinyl elastomer is a polymer (elastomer) composed of polymer blocks made up primarily of an aromatic vinyl compound, and random copolymer blocks made up of an aromatic vinyl compound and a conjugated diene compound. That is, the aromatic vinyl elastomer generally has, as exemplified by SEBS, blocks made up of an aromatic vinyl compound that are located at both ends of the polymer and serve as hard segments, and an intermediate block made up of a conjugated diene compound that is located between the ends and serves as a soft segment. Polymers in which an aromatic vinyl-based component has been randomly introduced into the conjugated diene compound component that makes up the intermediate block have also been reported in recent research. The hardness of the aromatic vinyl elastomer generally becomes lower as the content of the aromatic vinyl compound that forms the hard segments decreases; at the same time, because the amount of the soft segment component increases, the rebound resilience rises. On the other hand, in cases where an aromatic vinyl component is randomly introduced into the soft segment serving as the intermediate block, the rebound resilience decreases with little if any rise in the hardness. A similar effect can be obtained by using a conjugated diene compound having a high glass transition temperature (Tg) in place of the aromatic vinyl compound that is randomly introduced into the intermediate block.

Examples of the aromatic vinyl compound in the polymer include styrene, α-methylstyrene, p-methylstyrene, divinylbenzene, 1,1-diphenylethylene, N,N-dimethyl-p-aminoethylstyrene and N,N-diethyl-p-aminoethylstyrene. These may be used singly or two or more may be used together. Of these aromatic vinyl compounds, styrene is preferred.

Examples of the conjugated diene compound in the polymer include butadiene, isoprene, 2,3-dimethyl-1,3-butadiene, 1,3-pentadiene, 2-methyl-1,3-pentadiene and 1,3-hexadiene. These may be used singly or two or more may be used together. Of these compounds, butadiene and isoprene are preferred. Butadiene is more preferred.

Units originating from the above conjugated diene compounds, such as units originating from butadiene, become ethylene units or butylene units when subjected to hydrogenation. For example, when a styrene-butadiene-styrene block copolymer (SBS) is hydrogenated, it becomes a styrene-ethylene/butylene-styrene block copolymer (SEBS).

The aromatic vinyl elastomer used as component (II) may be one that has been hydrogenated; i.e., a hydrogenated aromatic vinyl elastomer. The hydrogenated aromatic vinyl elastomer is preferably an elastomer obtained by hydrogenating a polymer composed of polymer blocks made up primarily of an aromatic vinyl compound and random copolymer blocks made up of an aromatic vinyl compound and a conjugated diene compound, and more preferably an elastomer obtained by hydrogenating a polymer composed of polymer blocks made up primarily of styrene and random copolymer blocks made up of styrene and butadiene. An elastomer obtained by hydrogenating a polymer composed of polymer blocks made up primarily of styrene and random copolymer blocks made up of styrene and butadiene, particularly a polymer having at both ends a polymer block made up primarily of styrene (especially one having at each of the two ends a polymer block consisting entirely of styrene) and having a random copolymer block in between, is especially preferred. It is thought that a lower hardness and a lower resilience are both achieved by using a copolymer having this structure. Also, the rate of solidification after molding is rapid and so the degree of tack is low. In addition, the compatibility with (I) the polyurethane or polyurea serving as the chief material is excellent, enabling decreases in the physical properties owing to such blending to be minimized.

Illustrative examples of the hydrogenated aromatic vinyl elastomer include styrene-ethylene/butylene-styrene block copolymers (SEBS), styrene-isobutylene-styrene block copolymers (SIBS), styrene-isoprene-styrene block copolymers (SIS), styrene-isobutylene block copolymers (SIB), styrene-ethylene/propylene-styrene block copolymers (SEPS), styrene-ethylene/ethylene/propylene-styrene block copolymers (SEEPS), styrene-butadiene/butylene-styrene block copolymers (SBBS) and styrene-ethylene-propylene block copolymers (SEP).

In the aromatic vinyl elastomer, the proportion of the copolymer accounted for by units originating from the aromatic vinyl compound (i.e., the aromatic vinyl compound content, preferably the styrene content) is preferably at least 40 wt %, and more preferably at least 50 wt %, in cases where a styrene-ethylene/butylene-styrene block copolymer (SEBS) is used, and is preferably at least 15 wt %, and more preferably from 15 to 30 wt %, in cases where a styrene-isobutylene-styrene block copolymer (SIBS) is used. The content of units from the above aromatic vinyl compound (preferably the styrene content) can be determined by calculation from H¹-NMR measurements.

It is preferable to use a styrene-based thermoplastic elastomer as the above aromatic vinyl elastomer. The use of a styrene-isobutylene-styrene block copolymer (SIBS), specifically a completely saturated isobutylene-styrene thermoplastic elastomer having polymer blocks made of styrene at both ends and a polymer block made of isobutylene in between, is especially preferred. SIBS is composed of polystyrene and polyisobutylene, and the polyisobutylene serving as the soft segment, because it contains no unsaturated bonds whatsoever, is called a “completely saturated” isobutylene. Hence, unlike SBS and SIS, which have butadiene or isoprene with their unsaturated bonds as the soft segments on the backbone, and SEBS and SEPS in which these soft segments are hydrogenated, SIBS possesses a good thermal stability by having the soft segments be completely saturated isobutylene. Also, the polyisobutylene serving as a constituent of SIBS has two pendant methyl groups; the molecular motion of the backbone is suppressed owing to the influence of these methyl groups, resulting in a polymer which has flexibility and gas barrier properties. In addition, SIBS has a structure in which internal friction between molecules readily arises; the energy loss due to internal friction becomes large, resulting in high vibration-damping properties. In this invention, by including a small amount of such a completely saturated isobutylene-styrene thermoplastic elastomer in the polymer blend of polyurethane or polyurea serving as the resin base of the cover material, the controllability and feel of the ball on approach shots can be even further improved while retaining a good scuff resistance.

A commercial product may be used as the aromatic vinyl elastomer serving as component (II). Examples of such commercial products include those available under the trade name S.O.E. from Asahi Kasei Corporation and those available under the trade name SIBSTAR from Kaneka Corporation.

Component (II) has a material hardness on the Shore D hardness scale which, in order to increase the spin rate on approach shots, is 40 or less, preferably 35 or less, more preferably 30 or less, and even more preferably 23 or less. The lower limit is preferably at least 5.

Component (II) has a rebound resilience which, from the standpoint of maintaining the spin rate of the ball on approach shots, keeping the ball rebound on approach shots low and thus achieving a good controllability, is not more than 40%, preferably not more than 38%, and more preferably not more than 36%. By thus keeping the rebound resilience low, a small amount of addition will not have an adverse effect on the golf ball properties, enabling a decrease in the ball initial velocity on approach shots to be achieved. In order to minimize influences leading to a decrease in rebound and a reduction in distance on shots with a driver, the lower limit of the rebound resilience is preferably at least 15%, and more preferably at least 20%. This rebound resilience is measured in accordance with JIS-K 6255: 2013.

The content of component (II) per 100 parts by weight of component (I) is less than 15 parts by weight, and preferably 10 parts by weight or less. The lower limit in this content is preferably at least 1 part by weight, and more preferably at least 2 parts by weight. When the content of component (II) is too high, the scuff resistance and moldability may worsen. On the other hand, when the content of component (II) is too low, a good controllability and a good feel on approach shots may not be obtained.

Component (II) has a melt flow rate (MFR) which is preferably less than 12 g/10 min, more preferably 10 g/10 min or less, and even more preferably 6 g/10 min or less. The lower limit is at least 0.1 g/10 min. Because the MFR is low (meaning the flowability is poor) in this way, the dispersed state of component (II) within the matrix can be well maintained to some extent, making it easier for the golf ball cover to manifest a low rebound performance. This MFR value is measured in accordance with ISO 1133-1: 2011 at a test temperature of 230° C. and a test load of 21.18 N (2.16 kgf).

In addition to the above resin components, other resin materials may be included in the resin composition containing components (I) and (II). The purposes for doing so are, for example, to further improve the flowability of the golf ball resin composition and to enhance such ball properties as the rebound and the durability to cracking.

Specific examples of other resin materials that may be used include polyester elastomers, polyamide elastomers, ionomer resins, ethylene-ethylene/butylene-ethylene block copolymers and modified forms thereof, polyacetals, polyethylenes, nylon resins, methacrylic resins, polyvinyl chlorides, polycarbonates, polyphenylene ethers, polyarylates, polysulfones, polyethersulfones, polyetherimides and polyamideimides. These may be used singly or two or more may be used together.

In addition, an active isocyanate compound may be included in the above resin composition. This active isocyanate compound reacts with the polyurethane or polyurea serving as the chief ingredient, enabling the scuff resistance of the overall resin composition to be further enhanced. Moreover, the isocyanate has a plasticizing effect which increases the flowability of the resin composition, enabling the moldability to be improved.

Any isocyanate compound employed in ordinary polyurethanes may be used without particular limitation as the above isocyanate compound. Aromatic isocyanate compounds that may be used include, for example, 2,4-toluene diisocyanate, 2,6-toluene diisocyanate and mixtures of both, 4,4-diphenylmethane diisocyanate, m-phenylene diisocyanate and 4,4′-biphenyl diisocyanate. Use can also be made of the hydrogenated forms of these aromatic isocyanate compounds, such as dicyclohexylmethane diisocyanate. Other isocyanate compounds that may be used include aliphatic diisocyanates such as tetramethylene diisocyanate, hexamethylene diisocyanate (HDI) and octamethylene diisocyanate; and alicyclic diisocyanates such as xylene diisocyanate. Further examples of isocyanate compounds that may be used include blocked isocyanate compounds obtained by reacting the isocyanate groups on a compound having two or more isocyanate groups on the ends with a compound having active hydrogens, and uretdiones obtained by the dimerization of isocyanate.

The amount of the above isocyanate compounds included per 100 parts by weight of the polyurethane or polyurea resin serving as component (I) is preferably at least 0.1 part by weight, and more preferably at least 0.5 part by weight. The upper limit is preferably not more than 30 parts by weight, and more preferably not more than 20 parts by weight. When too little is included, a sufficient crosslinking reaction may not be obtained and improvements in the physical properties may not be observable. On the other hand, when too much is included, discoloration over time due to heat and ultraviolet light may increase, or problems such as a loss of thermoplasticity or a decline in resilience may arise.

In addition, depending on the intended use, optional additives may be suitably included in the above resin composition. For example, in cases where the golf ball material of the invention is to be used as a cover material, various additives such as fillers (inorganic fillers), organic staple fibers, reinforcing agents, crosslinking agents, pigments, dispersants, antioxidants, ultraviolet absorbers and light stabilizers may be added to the above ingredients. When including such additives, the amount thereof per 100 parts by weight of the base resin is preferably at least 0.1 part by weight, and more preferably at least 0.5 part by weight; the upper limit is preferably not more than 10 parts by weight, and more preferably not more than 4 parts by weight.

In order to achieve a suitable rebound and a suitable spin performance on approach shots, the above resin composition has a rebound resilience, as measured according to JIS-K 6255: 2013, which is preferably at least 48%, more preferably at least 50%, and even more preferably at least 52%. The upper limit is preferably not more than 72%, more preferably not more than 70%, and even more preferably not more than 68%.

The resin composition has a material hardness on the Shore D hardness scale which, from the standpoint of the scuff resistance and to impart a suitable spin rate on approach shots, is preferably not more than 50, more preferably not more than 48, and even more preferably not more than 45. In terms of the moldability, the lower limit in the material hardness on the Shore D hardness scale is preferably at least 30, more preferably at least 35, and even more preferably at least 37.

The above resin composition may be prepared by mixing together the ingredients using any of various types of mixers, such as a kneading-type single-screw or twin-screw extruder, a Banbury mixer, a kneader or a Labo Plastomill. Alternatively, the ingredients may be mixed together by dry blending when the resin composition is to be injection-molded. In addition, when an active isocyanate compound is used, it may be incorporated at the time of resin mixture using various types of mixers, or a resin masterbatch already containing the active isocyanate compound and other ingredients may be separately prepared and the various components mixed together by dry blending when the resin composition is to be injection molded.

The method of molding the cover from the above resin composition may involve, for example, feeding the resin composition into an injection molding machine and molding the cover by injecting the molten resin composition over the core. In this case, the molding temperature differs according to the type of polyurethane or polyurea (I) serving as the chief ingredient, but is typically in the range of 150° C. to 270° C.

The cover has a thickness which is preferably 0.4 mm or more, more preferably 0.5 mm or more, and even more preferably 0.6 mm or more. The upper limit is preferably not more than 3.0 mm, and more preferably not more than 2.0 mm.

In cases where at least one intermediate layer is interposed between the above core and the above cover, various types of thermoplastic resins used in golf ball cover materials, especially ionomer resins, may be used as the intermediate layer material. Commercial products may be used as the ionomer resins. In such a case, the thickness of the intermediate layer may be set within the same range as the above cover thickness.

In the golf ball of the invention, numerous dimples are provided on the surface of the outermost layer for reasons having to do with the aerodynamic performance. The number of dimples formed on the surface of the outermost layer is not particularly limited. However, to enhance the aerodynamic performance and increase the distance traveled by the ball, this number is preferably at least 250, more preferably at least 270, even more preferably at least 290, and most preferably at least 300. The upper limit is preferably not more than 400, more preferably not more than 380, and even more preferably not more than 360.

A coating layer may be formed on the surface of the cover in the golf ball of the invention. A two-part curable urethane coating may be suitably used as the coating that forms this coating layer. Specifically, in this case, the two-part curable urethane coating is one that includes a base resin composed primarily of a polyol resin and a curing agent composed primarily of a polyisocyanate.

A known method may be used without particular limitation as the method for applying this coating onto the cover surface and forming a coating layer. Use can be made of a desired method such as air gun painting or electrostatic painting.

The thickness of the coating layer, although not particularly limited, is typically from 8 to 22 μm, and preferably from 10 to 20 μm.

The golf ball of the invention can be made to conform to the Rules of Golf for play. The inventive ball may be formed to a diameter which is such that the ball does not pass through a ring having an inner diameter of 42.672 mm and is not more than 42.80 mm, and to a weight which is preferably between 45.0 and 45.93 g.

### EXAMPLES

The following Examples and Comparative Examples are provided to illustrate the invention, and are not intended to limit the scope thereof.

### Examples 1 to 10, Comparative Examples 1 and 2

### [Formation of Common Core]

A core-forming rubber composition formulated as shown in Table 1 and common to all of the Examples was prepared and then molded/vulcanized to produce a 38.6 mm diameter core.

TABLE 1

| Rubber composition | parts by weight |
|---|---|
| cis-1,4-Polybutadiene | 100 |
| Zinc acrylate | 27 |
| Zinc oxide | 4.0 |
| Barium sulfate | 16.5 |
| Antioxidant | 0.2 |
| Organic peroxide (1) | 0.6 |
| Organic peroxide (2) | 1.2 |
| Zinc salt of pentachlorothiophenol | 0.3 |
| Zinc stearate | 1.0 |

Details on the above core material are given below.
cis-1,4-Polybutadiene: Available under the trade name “BR01” from ENEOS Materials Corporation
Zinc acrylate: Available from Nippon Shokubai Co., Ltd.
Zinc oxide: Available from Sakai Chemical Co., Ltd.
Barium sulfate: Available from Sakai Chemical Co., Ltd.
Antioxidant: Available under the trade name “Nocrac NS6” from Ouchi Shinko Chemical Industry Co., Ltd.
Organic peroxide (1): Dicumyl peroxide, available under the trade name “Percumyl D” from NOF Corporation
Organic peroxide (2): A mixture of 1,1-di(tert-butylperoxy)cyclohexane and silica, available under the trade name “Perhexa C-40” from NOF Corporation
Zinc stearate: Available from NOF Corporation

### [Formation of Common Intermediate Layer]

An intermediate layer-forming resin material was injection-molded over the 38.6 mm diameter core, thereby producing an intermediate layer-encased sphere having a 1.25 mm thick intermediate layer. This intermediate layer-forming resin material, which was a resin blend common to all of the examples, consisted of 50 parts by weight of the sodium neutralization product of an ethylene-unsaturated carboxylic acid copolymer having an acid content of 18 wt % and 50 parts by weight of the zinc neutralization product of an ethylene-unsaturated carboxylic acid copolymer having an acid content of 15 wt %, for a total of 100 parts by weight.

### [Resin Composition of Cover (Outermost Layer)]

The resin compositions for the covers in the respective examples were prepared by using as the base resin (component (I)) an aromatic ether-type thermoplastic polyurethane (TPU) having a Shore D hardness of 40 available under the trade name Pandex from DIC Covestro Polymer, Ltd. and suitably compounding therewith component (II) or a corresponding resin component. Details on component (II) are shown below in Table 2.

TABLE 2

| | | SIBSTAR | SIBSTAR | SIBSTAR | SIBSTAR | S.O.E. |
|---|---|---|---|---|---|---|
| | | 062T | 073T | 102T | 103T | S1611 |
| Physical | Shore D hardness | 9 | 11 | 8 | 14 | 23 |
| properties | Rebound resilience (%) | 35 | 34 | 40 | 35 | 20 |
| | Melt flow rate | 10 | 6 | 0.6 | 0.1 | 12 |
| | Styrene content (%) | 23 | 30 | 15 | 30 | 60 |

Details on the resin ingredients in Table 2 are provided below.
SIBSTAR 062T, SIBSTAR 073T, SIBSTAR 102T and SUBSTAR 103T are all completely saturated isobutylene-styrene thermoplastic elastomers of the SIBSTAR Series available from Kaneka Corporation.
S.O.E. S1611 is a hydrogenated aromatic vinyl elastomer available from Asahi Kasei Corporation.

### [Physical Properties of Resin Compositions]

### (1) Shore D Hardness

Each of the above resins is formed into 2 mm thick sheets and left to stand for two weeks at a temperature of 23±2° C., following which three sheets are stacked together and the material hardness of the resin is measured using a Shore D durometer in accordance with ASTM D2240. The P2 Automatic Rubber Hardness Tester (Kobunshi Keiki Co., Ltd.) equipped with a Shore D durometer is used for measuring the hardness.

### (2) Rebound Resilience

The rebound resilience is measured in accordance with JIS-K 6255: 2013.

### (3) Flowability (MFR)

The melt flow rate (g/10 min) is measured in accordance with ISO 1133 at 230° C. and under a load of 2.16 kgf.

### [Cover (Outermost Layer)]

Next, the above cover-forming resin compositions was injection-molded over the intermediate layer-encased sphere, thereby producing a 42.7 mm diameter three-piece golf ball having a 0.8 mm thick outermost layer. Dimples common to all of the examples were formed at this time on the cover surface in each example according to the invention and each comparative example.

The coefficient of restitution, spin rate on approach shots, controllability on approach shots, feel at impact and scuff resistance of the golf balls produced in each example are evaluated by the following methods. The results are shown in Table 3.

### [Ball Coefficient of Restitution (COR)]

The COR value of the golf ball is measured using the ADC Ball COR Durability Tester manufactured by Automated Design Corporation (U.S.). This tester fires a golf ball pneumatically at an initial velocity of from 12 to 50 m/s. A velocity measurement sensor is located at a distance of about 0.8 meter. When the golf ball strikes a metal plate located at a distance of about 1.2 meters, the golf ball rebounds in such a way as to pass by the velocity measuring sensor. The COR value is the value obtained by dividing the rebound velocity by the initial velocity.

### [Spin Rate on Approach Shots]

A sand wedge (SW) is mounted onto a golf swing robot and the initial velocity and backspin rate of the ball immediately after being struck at a head speed (HS) of 20 m/s are measured with a launch monitor. The difference between the spin rates in the respective examples of the invention and in Comparative Example 1 is determined based on the backspin rate of the ball on approach shots in Comparative Example 1.

### [Controllability on Approach Shots]

Sensory evaluations of the ball controllability on approach shots are carried out by the following method. The club used is a sand wedge (SW) similar to that mentioned above: the TourStage TW-03 (loft angle, 57°) manufactured by Bridgestone Sports Co., Ltd. The controllability is evaluated based the following criteria when actually hit by golfers.

### [Evaluation Criteria]

Excellent (Exc): Outstanding controllability
Good: Good controllability
NG: Somewhat poor controllability

In addition to the spin rate of the ball, the length of the contact time between the ball and the clubface arising from the low resilience also affects the determination as to whether the controllability is good. When the contact time is long, the controllability is good; when it is short, the controllability worsens. What is being determined here is the controllability, which includes as factors the spin rate and the length of the contact time.

### [Feel]

A sensory evaluation on approach shots relating to the feel of the ball at impact is carried out as described below. The club used is the same sand wedge (SW) as that mentioned above.

[Evaluation Criteria]
Excellent (Exc): Feel on impact is good, with no clicky sound.
Good: A slight clicky sound occurs but is of a degree that does not pose a problem.
NG: A clicky sound occurs, resulting in an unpleasant feel at impact.

### [Evaluation of Scuff Resistance]

The golf balls are held isothermally at 23° C. and five balls of each type are hit at a head speed of 33 m/s using as the club a pitching wedge (PW) mounted on a golf swing robot. The damage to the ball from the impact is visually rated according to the following criteria.

### [Evaluation Criteria]

Good: No scuffing, or slight scuffing of a degree that is inconspicuous.
Fair: Slight scuffing.

TABLE 3

| | | | Comp. | | | | | |
|---|---|---|---|---|---|---|---|---|
| | | | Ex. | Example | | | | |
| | | | 1 | 1 | 2 | 3 | 4 | 5 |
| Cover | (I) | TPU | 100 | 100 | 100 | 100 | 100 | 100 |
| resin | (II) | 062T | | 5 | 10 | | | |
| formulation | | 073T | | | | 5 | 10 | |
| (pbw) | | 102T | | | | | | 5 |
| | | 103T | | | | | | |
| | (II″) | S1611 | | | | | | |
| Evaluation | COR | CV₁₂ | 0.914 | 0.911 | 0.911 | 0.912 | 0.912 | 0.912 |
| | | CV₂₀ | 0.882 | 0.888 | 0.887 | 0.889 | 0.888 | 0.889 |
| | | CV₄₀ | 0.800 | 0.806 | 0.804 | 0.805 | 0.804 | 0.805 |
| | | CV₄₅ | 0.779 | 0.780 | 0.781 | 0.781 | 0.781 | 0.780 |
| | | CV₅₀ | 0.759 | 0.759 | 0.759 | 0.760 | 0.759 | 0.760 |
| | | CS1 | −0.00408 | −0.00401 | −0.00400 | −0.00401 | −0.00400 | −0.00401 |
| | | CV_{12/45} | 1.173 | 1.169 | 1.167 | 1.168 | 1.167 | 1.169 |
| | | CV_{20/45} | 1.131 | 1.139 | 1.136 | 1.138 | 1.136 | 1.139 |
| | | CV_{40/45} | 1.026 | 1.033 | 1.030 | 1.031 | 1.029 | 1.032 |
| | | CV_{45/45} | 1.000 | 1.000 | 1.000 | 1.000 | 1.000 | 1.000 |
| | | CS2 | −0.00524 | −0.00512 | −0.00506 | −0.00510 | −0.00505 | −0.00511 |
| Spin rate difference on | | | — | −3 | −14 | −11 | −34 | −4 |
| approach shots (rpm) | | | | | | | | |
| Controllability on | | | NG | Exc | Exc | Exc | Exc | Exc |
| approach shots | | | | | | | | |
| Feel | | | Exc | Exc | Exc | Exc | Exc | Exc |
| Scuff resistance | | | good | good | good | good | good | good |
| | | | | | | | | Comp. |
| | | | Example | | | | | Ex. |
| | | | 6 | 7 | 8 | 9 | 10 | 2 |
| Cover | (I) | TPU | 100 | 100 | 100 | 100 | 100 | 100 |
| resin | (II) | 062T | | | | | | |
| formulation | | 073T | | | | | | |
| (pbw) | | 102T | 10 | | | | | |
| | | 103T | | 5 | 10 | | | |
| | (II″) | S1611 | | | | 5 | 10 | 15 |
| Evaluation | COR | CV₁₂ | 0.913 | 0.913 | 0.912 | 0.912 | 0.911 | 0.910 |
| | | CV₂₀ | 0.887 | 0.882 | 0.881 | 0.880 | 0.879 | 0.878 |
| | | CV₄₀ | 0.805 | 0.804 | 0.803 | 0.799 | 0.798 | 0.797 |
| | | CV₄₅ | 0.782 | 0.781 | 0.782 | 0.779 | 0.778 | 0.777 |
| | | CV₅₀ | 0.760 | 0.760 | 0.760 | 0.759 | 0.758 | 0.757 |
| | | CS1 | −0.00401 | −0.00402 | −0.00400 | −0.00405 | −0.00403 | −0.00402 |
| | | CV_{12/45} | 1.167 | 1.168 | 1.167 | 1.171 | 1.171 | 1.171 |
| | | CV_{20/45} | 1.134 | 1.128 | 1.127 | 1.130 | 1.130 | 1.129 |
| | | CV_{40/45} | 1.029 | 1.029 | 1.027 | 1.026 | 1.026 | 1.026 |
| | | CV_{45/45} | 1.000 | 1.000 | 1.000 | 1.000 | 1.000 | 1.000 |
| | | CS2 | −0.00507 | −0.00510 | −0.00507 | −0.00520 | −0.00518 | −0.00517 |

| | | | | | | |
|---|---|---|---|---|---|---|
| Spin rate difference on | −8 | +15 | +20 | −49 | −74 | −98 |
| approach shots (rpm) | | | | | | |
| Controllability on | Exc | Exc | Exc | Exc | Exc | Exc |
| approach shots | | | | | | |
| Feel | Exc | Exc | Exc | good | good | NG |
| Scuff resistance | good | good | good | good | good | fair |

As demonstrated by the results in Table 3, the golf balls of Comparative Examples 1 and 2 are inferior in the following respects to the golf balls according to the present invention obtained in Examples 1 to 10.

In Comparative Example 1, component (II) is not included in the resin composition and the CS₁ value is small. As a result, the controllability on approach shots is inferior.

In Comparative Example 2, component (II) is not included in the resin composition. As a result, the feel at impact and the scuff resistance are insufficient, in addition to which the spin rate on approach shots decreases.

Japanese Patent Application No. 2023-166774 is incorporated herein by reference. Although some preferred embodiments have been described, many modifications and variations may be made thereto in light of the above teachings. It is therefore to be understood that the invention may be practiced otherwise than as specifically described without departing from the scope of the appended claims.

1. A golf ball comprising a rubber core of at least one layer and a cover of at least one layer encasing the core, wherein at least one layer of the cover is formed of a resin composition comprising:
(I) a polyurethane or a polyurea, and
(II) an aromatic vinyl elastomer;
the amount of component (II) included per 100 parts by weight of component (I) is less than 15 parts by weight; and
the CS₁ value calculated by formula (1) below
$$C {S}_{1} = ( C {V}_{50} - C {V}_{12} ) / 38 \qquad ( 1 )$$
(wherein CV₅₀ is the coefficient of restitution at an incident velocity of 50.0 m/s and CV₁₂ is the coefficient of restitution at an incident velocity of 12.0 m/s) is larger than −4.08×10⁻³.

2. The golf ball of claim 1, wherein the CS₂ value calculated by formula (2) below
$$C {S}_{2} = ( 1. - {CV}_{12 / 45} ) / 33 \qquad ( 2 )$$
(wherein CV_{12/45} is the coefficient of restitution at an incident velocity of 12.0 m/s when the coefficient of restitution at an incident velocity of 45.0 m/s is set to 1.0) is larger than −5.23×10⁻³.

3. The golf ball of claim 1, wherein component (II) has a melt flow rate (MFR), as measured at 230° C. and under a load of 2.16 kgf (ISO 1133), which is smaller than 12 g/10 min.

4. The golf ball of claim 1, wherein component (II) is a completely saturated isobutylene-styrene thermoplastic elastomer having polymer blocks made of styrene at both ends and a polymer block made of isobutylene in between.

5. The golf ball of claim 1, wherein component (II) has a rebound resilience of from 20 to 40%.

6. The golf ball of claim 1, wherein component (II) has a Shore D hardness of 23 or less.

7. The golf ball of claim 4, wherein the styrene content of component (II) is 15 wt % or more.

8. The golf ball of claim 4, wherein the styrene content of component (II) is from 15 to 30 wt %.
